(19) United States
(12) Patent Application Publication
(10) Pub. No.: US 2012/0052236 A1
(43) Pub. Date: Mar. 1, 2012

(54) METHOD FOR PRODUCING STRUCTURAL FOAM AND PRODUCTS CONTAINING STRUCTURAL FOAM

(75) Inventor: Efraim Haimoff, Mevaseret Zion (IL)

(73) Assignee: KETER PLASTIC LTD., Herzelyia (IL)

(21) Appl. No.: 13/318,619

(22) PCT Filed: May 4, 2010
(86) PCT No.: PCT/IL10/00352

§ 371 Date: Nov. 3, 2011

(51) Int. Cl. B32B 3/06; C08F 110/06; C08F 110/02; B29C 44/46; B32B 3/26

(52) U.S. Cl. 428/99; 264/51; 428/304.4; 521/143

(57) ABSTRACT

Provided is a method for generating structural foam having a density in the range of from 0.4 to 0.75 gr/cm³. A gas is generated in a plastic melt under conditions inhibiting bubble formation in the melt. The melt is injected into a mold and the volume of the mold is varied to produce a structural foam having a density in the specified range. Also provided is a sheet of structural foam having a density in the range of from 0.4 to 0.75 gr/cm³ and a panel including a sheet of structural foam. Also provided is a structure including two or more panels. The structure may be, for example, a cabinet, cupboard, shed or piece of furniture.

### FIELD OF THE INVENTION

This invention relates to methods for producing structural foam and to products containing structural foam.

### BACKGROUND OF THE INVENTION

The term “structural foam” is used to denote molded parts having a cellular interior structure. Structural foam can be made from such materials as polyethylene and polypropylene. Structural foam products have a low density, cellular interior structure sandwiched between two superficial high density layers. The cellular structure is produced during injection molding by generation of gas bubbles within the polymer melt when the melt is exposed to heat during the plasticizing process. The gas bubbles may be generated either chemically or mechanically. In chemically blown foam, a powdered blowing agent is mixed into the polymer melt together with an adhesive oil. Mechanically blown foam is produced by introducing pressurized nitrogen or carbon dioxide directly into the melt during the plasticizing process.

In comparison to a solid panel made from the same material, a structural foam panel has a significantly lower density but is only slightly weaker than the solid panel of the same thickness. Thus, a structural foam panel has to be slightly thicker than the solid panel of comparable strength. Nonetheless, a structural foam panel will still have a significantly lower weight than a solid panel of comparable strength made from the same material. Use of structural foam panels thus allows a significant savings in the polymer material while a structure, such as a cabinet, having structural foam panels is significantly lighter than a cabinet made from solid panels of the same material. It is known to use structural foam panels in cabinets and similar structures having a density of about 0.9 gr/cm³. Structural foam panels of lower density have not found use in large structures such as cabinets, cupboards and shed due their tendency to buckle under the weight of the structure and any contents inside the structure.

### SUMMARY OF THE INVENTION

In its first aspect, the present invention provides a method for producing structural foam. In accordance with this aspect of the invention, plasticizing granules are heated causing plasticizing of the plastics. A gas or a powdered blowing agent is introduced into the melt which is then injected into a mold. Initially, the mold is closed to an initial volume V1 as a volume V2 of the melt is injected into the mold, where V2<V1. The mold is then compressed from the volume V1 to the volume V2. As the volume of the mold is decreased to the volume of the melt in the mold, the melt is pressed to completely fill the mold. The mold is then expanded from the volume V2 to a final volume V3. As the volume of the mold increases, the pressure in the mold decreases, and the melt expands by the formation of gas bubbles inside the melt so that the melt completely fills the expanded mold. The already solidified surface layers of the melt cannot foam up, but the liquid melt of the core section does foam up and expands. As the core expands, it pushes the surface layers apart causing the melt to fill the previously unoccupied mold volume until both surface layers are pressed against the mold walls. A structure is generated in the molded part 18 in which in the surface skin layers the plastic are dense, while in the interior of the molded part, a microcellular foam core is formed.

In accordance with the invention, the volumes V1, V2, and V3 are selected to yield a structural foam product having a density in the range of 0.4-0.75 gr/cm³. For example, the inventors have found that, in order to produce a sheet having a specific gravity in the range of 0.4-0.75 gr/cm³ the following procedure may be used:

Initial thickness of the mold during injection of the melt (corresponding to the volume V1): 1.8-4 mm.

Second thickness of the mold to press the melt and to completely fill the mold (corresponding to the volume V2): 1-2 mm.

Final thickness of the mold (corresponding to the volume V3): 1.5-6 mm.

In its second aspect, the invention provides a panel. The panel of the invention comprises a sheet of structural foam. In accordance with the invention, the sheet of structural foam has a density in the range of 0.4-0.75 gr/cm³. The sheet may be made from any material known to be used in the manufacture of structured foam such as polyethylene and polypropylene. The sheet of the panel is surrounded by a frame. The inventors have found that a panel of the invention can be constructed having a strength comparable to that of prior art structural foam panels of higher density. The low density of the panel allows a significant savings in the amount of polymer in the panel, and hence allows a significant reduction in the weight of and manufacturing cost of a structure comprising the panels.

In its third aspect, the present invention provides a structure comprising a plurality of panels of the invention the structure may be, for example, a cabinet, cupboard, shed, or a piece of furniture.

Thus, in its first aspect, the present invention provides a method for generating structural foam having a density in the range of 0.4-0.75 gr/cm³ comprising:

(a) plasticizing plastics granules to form a polymer melt;

(b) generating a gas in the melt under conditions inhibiting bubble formation in the melt;

(c) closing a mold to an initial volume V1;

(d) injecting a volume V2 of the melt into the mold, where V2<V1;

(e) compressing the mold from the volume V1 to the volume V2; and
(f) expanding the mold from the volume V2 to a final volume V3;
   wherein V1, V2, and V3 are selected to produce a structural foam having a density in the range of 0.4-0.75 gr/cm³.

In its second aspect; the invention provides a sheet of structural foam having a density in the range of 0.4-0.75 gr/cm3 produced by the method of the invention.

In it third aspect, the invention provides a panel comprising a sheet of structural foam of the invention.

In its fourth aspect, the invention provides a structure comprising two or more panels of the invention.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a method for producing structural foam in accordance with one embodiment of the invention;

FIG. 2 shows a sheet of structural foam produced by the method of the invention;

FIG. 3 shows a panel containing a sheet of structural foam produced by the method of the invention in accordance with one embodiment of the invention; and

FIG. 4 shows a structure comprising a plurality of panels of the invention.

### DETAILED DESCRIPTION OF EMBODIMENTS

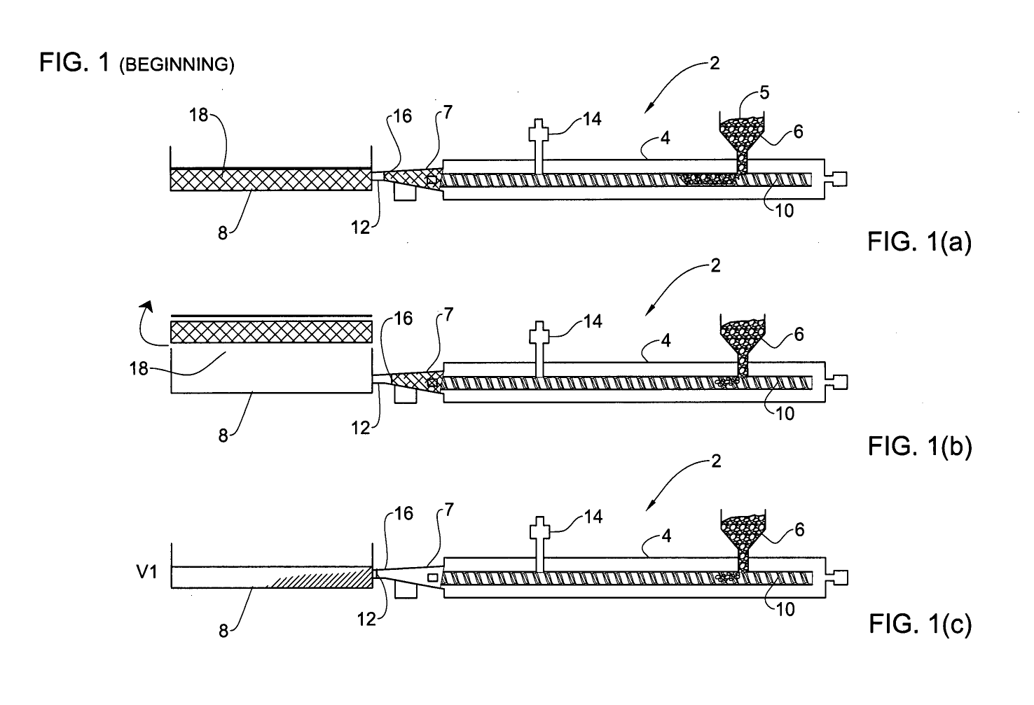

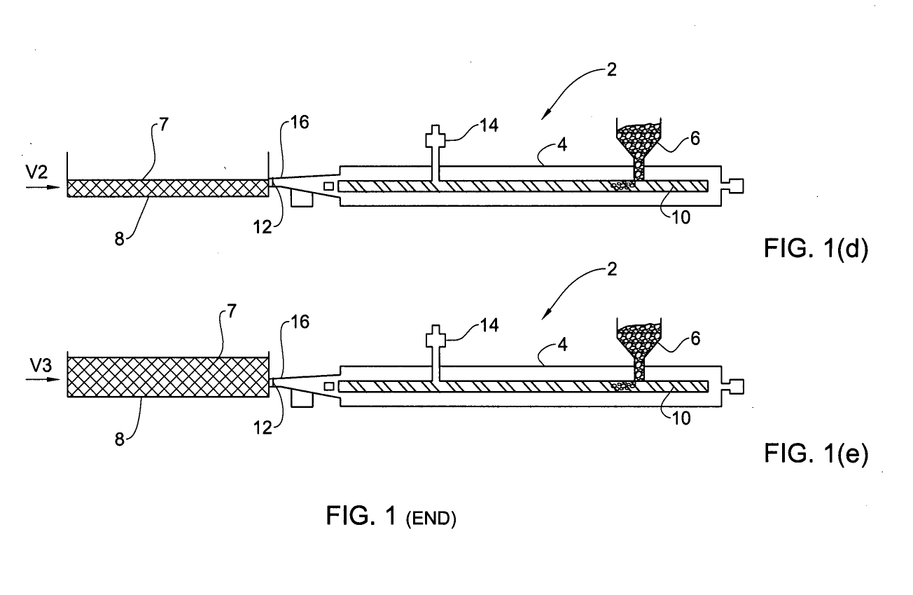

FIG. 1 shows schematically a method for generating structural foam in accordance with one embodiment of the invention. The method of FIG. 1 utilizes a manufacturing system 2 comprising a plasticizing unit 4. A vat 6 stores plastic granules 5 and introduces the granules into the plasticizing unit 4. A plasticizing screw 10 drives the granules towards the nozzle 12. As the granules are transported in the plasticizing unit, the granules are heated causing plasticizing of the plastics. One or more side ports 14 are used to introduce either gasses (in the case of mechanical blowing) or a powdered blowing agent (in the case of chemical blowing) into the melt, which is then injected through the nozzle 12 into a mold 8, as described below.

FIG. 1 shows five phases in the method of the invention for producing structural foam in accordance with the invention. In the first phase, shown in FIG. 1a, plasticizing of granules takes place in the plasticizing unit 4 between the vat 6 and the side ports 14 after injection of the previous shot into the mold 8 and during the mold cooling phase. A gas or a powdered blowing agent is introduced into the melt via the side ports 14. With the valve 16 of the nozzle 12 closed, the melt 7 builds up in the space in front of the screw 10. The back pressure keeps the melt under pressure, typically, in the range of 5-10 MPa during plastication so that formation of gas bubbles in the melt is inhibited.

In the second phase, (FIG. 1b), the mold 8 is opened and the part 18 is demolded. The melt for the next shot is kept under pressure so as to ensure a uniform melt temperature which is important in order to obtain a uniform foam structure in the molded part.

In the third phase, shown in FIG. 1c, the mold 8 is closed to an initial volume V1 and the nozzle valve 16 is opened and a volume V2 of the melt 7 is injected into the mold 8, where V2<V1. Since the volume of the melt that is introduced into the mold is less than the present volume of the mold, a lower injection pressure may be used than is required when the injection volume equals the mold volume. The inventors have found that an injection pressure of about 400 tons may be used, in comparison with pressures of about 800 tons which are typically used in injection molding using a fixed volume mold.

In the fourth phase (FIG. 1d), the mold 8 is compressed from the volume V1 to the volume V2. As the volume of the mold is decreased to the volume of the melt in the mold, the melt is pressed to completely fill the mold. During this stage the surface layers of the melt solidify to form a “skin” on the surface of the melt, while the core of the melt is still molten.

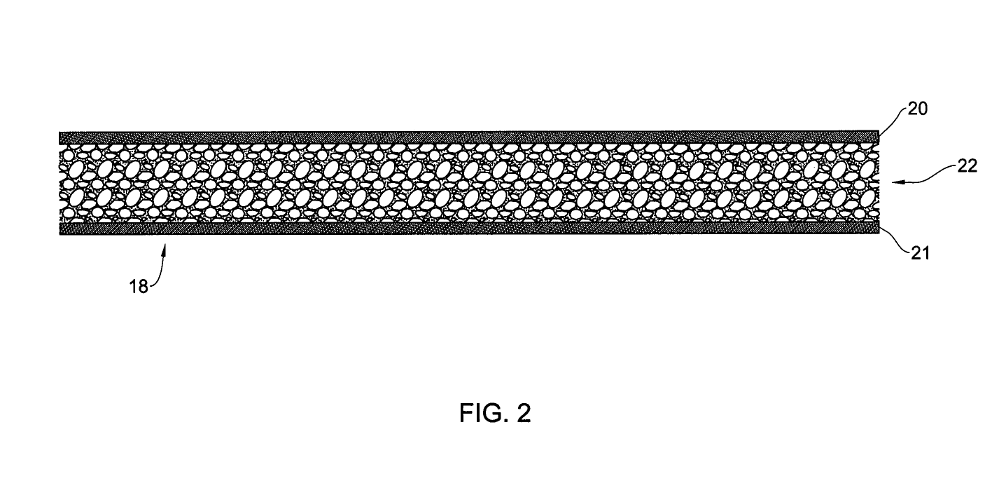

In the fifth phase, (FIG. 1e), the mold 8 is expanded from the volume V2 to a final volume V3. As the volume of the mold 8 increases, the pressure in the mold decreases, and the melt expands by the formation of gas bubbles inside the melt so that the melt completely fills the expanded mold. The already solidified surface layers of the melt cannot foam up, but the liquid melt of the core section does foam up and expands. As the core expands, it pushes the surface layers apart causing the melt to fill the previously unoccupied mold volume until both surface layers are pressed against the mold walls. Thus, as shown in FIG. 2, a structure is generated in the molded part 18 in which in the superficial skin layers 20 and 21 the plastic are dense, while in the interior 22 of the molded part 18, a microcellular foam core is formed.

In accordance with the invention, the volumes V1, V2, and V3 are selected to yield a structural foam product having a density in the range of 0.4-0.75 gr/cm³. For example, the inventors have found that, in order to produce a panel having a specific gravity in the range of 0.4-0.75 gr/cm³ the following procedure may be used:

Initial thickness of the mold during injection of the melt (corresponding to the volume V1): 1.8-4 mm.

Second thickness of the mold to press the melt and to completely fill the mold (corresponding to the volume V2): 1-2 mm.

Final thickness of the mold (corresponding to the volume V3): 1.5-6 mm.

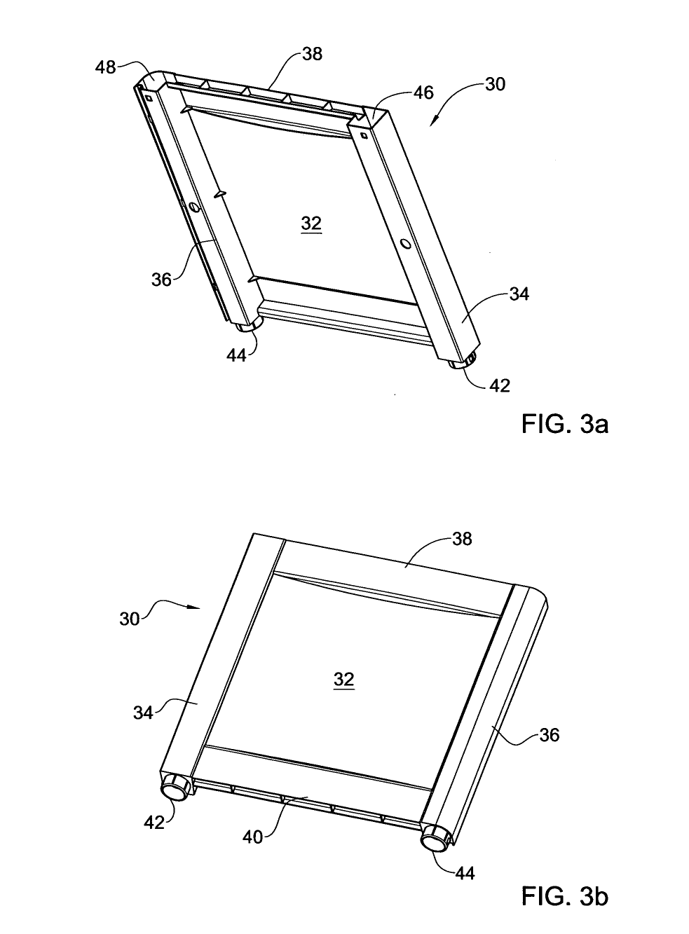

FIGS. 3 and 3b show two perspective views of a panel 30 in accordance with one embodiment of the invention. The panel 30 may be used, for example, in a structure such as a cabinet, cupboard or shed. The panel 30 comprises a sheet 32 of structural foam. In accordance with the invention, the sheet of structural foam 32 has a density in the range of 0.4-0.75 gr/cm³. The sheet 32 may be made from any material known to be used in the manufacture of structured foam such as polyethylene and polypropylene.

In the panel 30, the sheet 32 is surrounded by a frame comprising a first lateral support 34 and a second lateral support 36, a top support 38 and a bottom beam 40. At the bottom of the first and second lateral supports 34 and 36 are tenons 42 and 44, respectively. At the top of the first and second lateral supports 34 and 36 are mortices 46 and 48 that are shaped to snugly receive the tenons 42 and 44, respectively, of an identical panel when two or more panels 30 are to be joined together into a larger structure, as explained below.

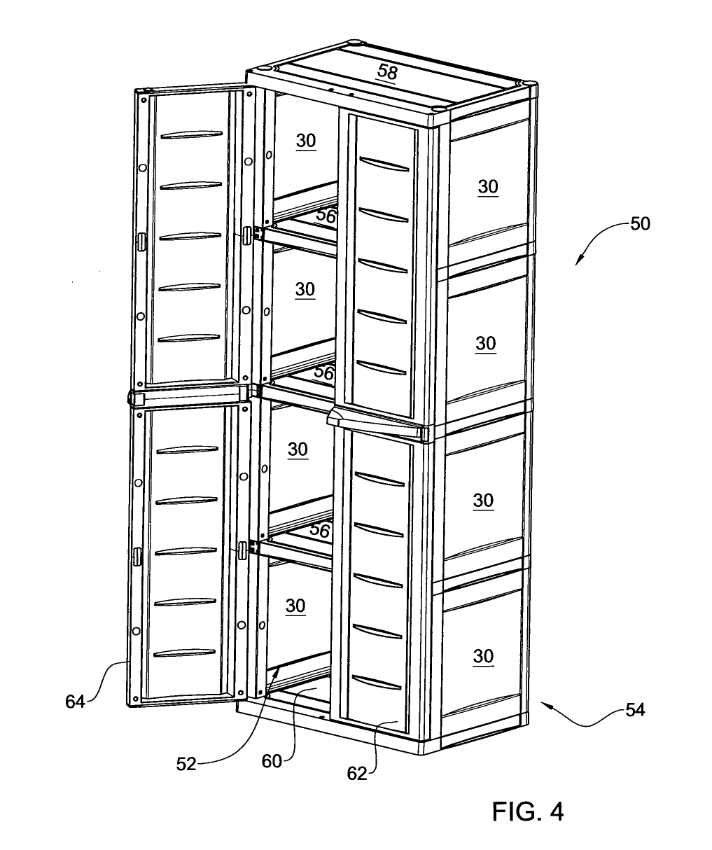

FIG. 4 shows a structure 50 comprising a plurality of panels of the invention. The structure 50 is a cabinet. This is by way of example only, and the panels of the invention can be assembled into any kind of structure, such as a cupboard, shed, or a piece of furniture. The cabinet 50 has a left side 52 and a right side 54. The left and right sides 52 and 54 are assembled from a plurality of the panels 30. The cabinet 50 also comprises a back panel (not visible in the view shown in FIG. 4) that is also assembled from a plurality of panels of the invention but having different dimensions than the dimensions of the panels 30. The cabinet 50 has a top panel 58 of the invention and a bottom panel 60 of the invention. The cabinet 50 also comprises a plurality of shelves 56, which are also panels of the invention. Each shelf 56 is supported by a bottom support 40 of one of the panels 30. The cabinet 50 also comprises a pair of hinged doors 62 and 64 that are panels in accordance with the invention.

1-11. (canceled)

12. A method for generating structural foam having a density in the range of from 0.4 to 0.75 gr/cm³ comprising:
plasticizing plastics granules to form a polymer melt;
generating a gas in the melt under conditions inhibiting bubble formation in the melt;
closing a mold to an initial volume V1;
injecting a volume V2 of the melt into the mold, where V2<V1;
compressing the mold from the volume V1 to the volume V2; and
expanding the mold from the volume V2 to a final volume V3;
wherein V1, V2, and V3 are selected to produce a structural foam having a density in the range of from 0.4 to 0.75 gr/cm³.

13. The method according to claim 12, wherein:
an initial thickness of the mold during injection of the melt is in the range of from 1.8 to 4 mm;
a second thickness of the mold after compression of the mold is in the range of from 1 to 2 mm; and
a final thickness of the mold is in the range of from 1.5 to 6 mm.

14. The method according to claim 12, wherein the structural foam is made from polyethylene or polypropylene.

15. A sheet of structural foam having a density in the range of from 0.4 to 0.75 gr/cm³ produced by the method according to claim 12.

16. A panel comprising a sheet of structural foam according to claim

17. The panel according to claim 16, further comprising a frame surrounding the sheet.

18. The panel according to claim 17, configured to be attached to at least one other panel.

19. The panel according to claim 18, comprising one or more tenons provided on a first side of the panel and one or more mortises provided on a second side of the panel.

20. A structure comprising two or more panels according to claim 17.

21. The structure according to claim 20, wherein two or more of the panels are assembled together into a larger panel.

22. The structure according to claim 20, being a cabinet, cupboard, shed, or a piece of furniture.
